(19) United States
(12) Patent Application Publication
(10) Pub. No.: US 2026/0084518 A1
(43) Pub. Date: Mar. 26, 2026

(54) TEMPERATURE ADJUSTMENT APPARATUS FOR VEHICLE

(71) Applicant: HONDA MOTOR CO., LTD., Tokyo (JP)

(72) Inventor: Takuya HONJO, Tokyo (JP)

(21) Appl. No.: 19/330,266

(22) Filed: Sep. 16, 2025

(30) Foreign Application Priority Data
Sep. 25, 2024 (CN) 20241339756.9

(51) Int. Cl. B60K 11/08

(52) U.S. Cl. CPC B60K 11/085

(57) ABSTRACT

In the temperature adjustment apparatus for the vehicle, a grill shutter 40 is provided with a plurality flaps 41 for setting a grill opening to an open state or a closed state, and a frame body 401 in which the flaps 41 are arranged, the flaps 41 arranged in the frame body 401 include a first flap 41-1 that enters an open state or a closed state when a motive power source in the vehicle enters a prescribed state, and a second flap 41-2 that has a smaller opening area than an opening area for the first flap 41-1 and enters an open state or a closed state regardless of the prescribed state of the motive power source.

This application is based on and claims the benefit of priority from Chinese Patent Application No. CN202411339756.9, filed on 25 Sep. 2024, the content of which is incorporated herein by reference.

### BACKGROUND OF THE INVENTION

### Field of the Invention

The present invention pertains to a temperature adjustment apparatus for a vehicle.

### Related Art

In the past, a vehicle that is provided with a grill shutter that opens and closes is known. For example, Japanese Patent No. 4887914 describes this type of technology. The grill shutter opens when a condenser or battery reaches a prescribed temperature or more, and a grill opening in the vehicle opens. In the technology described in Japanese Patent No. 4887914, a shutter plate and an air guide plate are driven independently, whereby when the shutter plate is closed, the direction of outside air introduced using the air guide plate is changed, and cooling is performed by causing the outside air to circulate to a position facing the shutter plate in a forward-rearward direction.
Patent Document 1: Japanese Patent No. 4887914

### SUMMARY OF THE INVENTION

When a grill shutter opens due to a condenser or a battery reaching a prescribed temperature or more during travel, air resistance increases, whereby a decrease in fuel efficiency occurs. Accordingly, it is necessary to suppress a rise in the temperature of the condenser or battery in order to delay the grill shutter entering the open state.

In addition, when the grill shutter enters the open state while heat is generated in charging or in circumstances of aftercooling after travel, the inside of the grill enters a visually recognizable state, and the appearance and merchantability are reduced. In addition, in order to suppress a rise in temperature even if the grill shutter is in the closed state, forming an opening in a portion of the grill shutter and always producing an air flow can be considered. However, in this case, because the inside of the grill enters a visually recognizable state during a normal stop by a vehicle in which aftercooling or charging are not performed, the appearance and merchantability of the vehicle are reduced.

An object of the present invention is to provide a temperature adjustment apparatus that is for a vehicle and can set a portion of a grill shutter to an open state even in a state when the temperature of a condenser, battery, or the like is less than or equal to a prescribed temperature, and can delay the condenser or battery reaching the prescribed temperature or more.

(1) The present invention pertains to a temperature adjustment apparatus for a vehicle, the apparatus including: a grill opening formed in a front section of the vehicle; and a grill shutter that covers the grill opening, the grill shutter including a plurality of flaps for setting the grill opening to an open state or a closed state, and a frame body in which the flaps are arranged, and the flaps arranged in the frame body including a first flap that enters an open state or a closed state when a motive power source in the vehicle enters a prescribed state, and a second flap that has a smaller opening area than an opening area for the first flap, and enters an open state or a closed state regardless of the prescribed state of the motive power source.

By virtue of the invention according to (1), even if a prescribed state is reached in which the temperature of a condenser or a battery has become less than or equal to a prescribed temperature, for example, it becomes possible to set a portion of the grill shutter to an opened state, and it becomes possible to set the entirety of the grill shutter to the closed state while the vehicle is stopped and while the vehicle is traveling at low speed. As a result, while the vehicle is traveling, it is possible to reduce air resistance and improve the appearance and merchantability of the vehicle, and, for example, it becomes possible to suppress and delay the temperature of the condenser or the battery from reaching a prescribed temperature at which the entirety of the grill shutter opens and the prescribed state for the motive power source is reached.

In addition, even in a case where the grill shutter opens while the vehicle is stopped such as at a time of charging or aftercooling, by providing the second flap, it is possible to set only a portion of the grill shutter to open, and thus it becomes possible to suppress a drop in the appearance and merchantability of the vehicle.

(2) The temperature adjustment apparatus according to (1), further including a fan shroud that is rearward from the grill shutter, the second flap entering the open state when the fan shroud operates.

By virtue of the invention according to (2), when the fan shroud is operated, the second flap enters the open state, whereby it is possible to produce an air flow using the fan shroud. Therefore, it is possible to suppress a rise in the temperature of the motive power source, and the second flap is set to the open state without setting the first flap to the open state, whereby it becomes possible to suppress the air resistance while the vehicle is traveling.

(3) The temperature adjustment apparatus according to claim (2), the fan shroud operating when the motive power source in the vehicle reaches a prescribed temperature or more.

By virtue of the invention according to (3), the fan shroud is caused to operate when the motive power source has reached the prescribed temperature or more, whereby the second flap enters the open state while the fan shroud is operating. Therefore, it is possible to suppress a rise in the temperature of the motive power source, and it becomes possible to improve the appearance and merchantability of the vehicle by setting only the second flap to the open state at a time of cooling while the vehicle is stopped, such as cooling after the vehicle has traveled or for heat generated when charging.

(4) The temperature adjustment apparatus according to (1), the second flap entering the open state due to dynamic pressure that is a certain level or more and regardless of the prescribed state of the motive power source.

By virtue of the invention according to (4), the second flap enters the open state due to dynamic pressure of a certain level or more, whereby it becomes possible to set a gearing for causing the flaps to open and close to be only for opening and closing the first flap and, since there is no need to provide a gearing for the second flap, it is possible to reduce the weight and cost associated with the apparatus. In addition, the second flap enters the open state due to the dynamic pressure of the certain level or more, whereby it becomes possible for the second flap not to enter the open state due to natural wind while the vehicle is stopped or traveling wind while the vehicle is traveling slowly, and it becomes possible to suppress air resistance while the vehicle is traveling to thereby improve the appearance and merchantability thereof.

(5) The temperature adjustment apparatus according to (1), the vehicle including a cooling mechanism that is rearward from the grill shutter, the cooling mechanism including an engine radiator, a motor radiator, and an air conditioner condenser, and the second flap being disposed at a position that overlaps with the motor radiator in a vehicle body forward/rearward direction.

By virtue of the invention according to (5), a temperature (a required temperature) that is required for a coolant in a motor radiator (HEV RAD) is lower than required temperatures for an engine radiator and an air conditioner condenser. Therefore, further cooling to achieve a lower temperature is necessary. The second flap is disposed at a position that overlaps with the motor radiator in the forward-rearward direction for the vehicle, whereby it becomes possible to use the flow of air while the second flap can move to achieve a lower temperature for the motor radiator.

(6) The temperature adjustment apparatus according to (5), further including a fan shroud that is rearward from the cooling mechanism, the fan shroud including a frame body and a rotor that is disposed at the center of the frame body, and the frame body including an opening at a position that overlaps with the motor radiator in the vehicle body forward/rearward direction.

By virtue of the invention according to (6), by driving the fan shroud, it is possible to enable the second flap to move, and thus it is possible to enable the second flap to move if necessary, even when the vehicle is not traveling at low speed. For example, in a case of using a gearing to drive the flaps, all of the flaps will operate, leading to a drop in the appearance and merchantability of the vehicle. Therefore, it is necessary to enable only the second flap to move. In such a case, the frame body belonging to the fan shroud is provided with the opening, whereby it is possible to supply, to the opening side, air flow that has flowed to the rotor. Accordingly, the motor radiator is disposed at a position that overlaps with the opening in the forward-rearward direction, whereby it is possible to further cool the motor radiator.

(7) The temperature adjustment apparatus according to (1), the grill shutter including a gearing that sets the first flap to the open state or the closed state, and a link that is connected to the plurality of first flaps, and the second flap being disposed separated from the link.

By virtue of the invention according to (7) the plurality of first flaps are connected to the link and the second flap is disposed separated from the link, whereby it is possible to constrain an increase in the number of gearings for driving the flaps and to set the second flap to the open state regardless of opening and closing in accordance with the gearing.

(8) The temperature adjustment apparatus according to (7), the first flap having, at an end in the width direction of the first flap, a connection section that is connected to the link.

By virtue of the invention according to (8), the supported sections of the first flaps are connected and joined to each other by the link, whereby it is possible to use a gearing to set the plurality of first flaps to the open state or the closed state.

(9) The temperature adjustment apparatus according to (8), the link including a contact driving member, and, when the first flap is in the open state, the contact driving member pressing on the second flap to set the second flap to the open state.

By virtue of the invention according to (9), the second flap can move to the open state due to dynamic pressure, and it is possible for the second flap to operate together with the first flaps due to being pressed by the contact driving member when the gearing has operated.

(10) The temperature adjustment apparatus according to (1), including a ventilation opening at a rearward lower section of the grill shutter, wherein the second flap is positioned upward from the ventilation opening in an up-down direction.

By virtue of the invention according to (10), the second flap is positioned upward of the ventilation opening, whereby it is possible to produce air flow that is toward the cooling mechanism that cools the motive power source in a case where only the second flap could move while the vehicle is traveling at low speed. Accordingly, in a case where, for example, the second flap is disposed at the same height as the ventilation opening, there would be the difficulty in that air that has passed through the second flap would flow directly into the ventilation opening in an unchanged manner, increasing the air volume supplied to the cooling mechanism, but it is possible to avoid this difficulty.

By virtue of the present invention, it is possible to provide a temperature adjustment apparatus that is for a vehicle and can set a portion of a grill shutter to an open state even in a state when a condenser, battery, or the like is less than or equal to a prescribed temperature, and can delay the condenser or battery reaching the prescribed temperature or more.

### BRIEF DESCRIPTION OF THE DRAWINGS

FIG. 1 is a perspective view that illustrates a front section of a vehicle that is provided with a temperature adjustment apparatus according to a first embodiment of the present invention;

FIG. 2 is a view that is seen from in front and is for describing the front section of the vehicle that is provided with the temperature adjustment apparatus according to the first embodiment of the present invention;

FIG. 3 is a front view that illustrates a grill shutter of the temperature adjustment apparatus according to the first embodiment of the present invention;

FIG. 4 is a view that is seen from a side and is for describing a configuration of the front section of the vehicle that is provided with the temperature adjustment apparatus according to the first embodiment of the present invention;

FIG. 5 is a front view that illustrates a fan shroud of the temperature adjustment apparatus according to the first embodiment of the present invention;

FIG. 6 is a view that is seen from in front and is for describing ventilation openings in the temperature adjustment apparatus according to the first embodiment of the present invention;

FIG. 7 is a view that is seen from a side and is for describing the ventilation openings in the temperature adjustment apparatus according to the first embodiment of the present invention;

FIG. 8 is a lateral cross-sectional view that is for describing the flow of air that is introduced through the grill shutter in the temperature adjustment apparatus according to the first embodiment of the present invention;

FIG. 9 is a lateral cross-sectional view that is for describing the flow of air that is introduced through the ventilation openings in the temperature adjustment apparatus according to the first embodiment of the present invention;

FIG. 10 is an enlarged perspective view that illustrates a configuration for driving first flaps in a grill shutter in the temperature adjustment apparatus according to the first embodiment of the present invention;

FIG. 11 is an enlarged perspective view that illustrates a closed state and an open state for the first flaps and a second flap in a grill shutter in the temperature adjustment apparatus according to the first embodiment of the present invention; and

FIG. 12 is an enlarged perspective view that illustrates a second flap in a grill shutter in a temperature adjustment apparatus according to a second embodiment of the present invention.

### DETAILED DESCRIPTION OF THE INVENTION

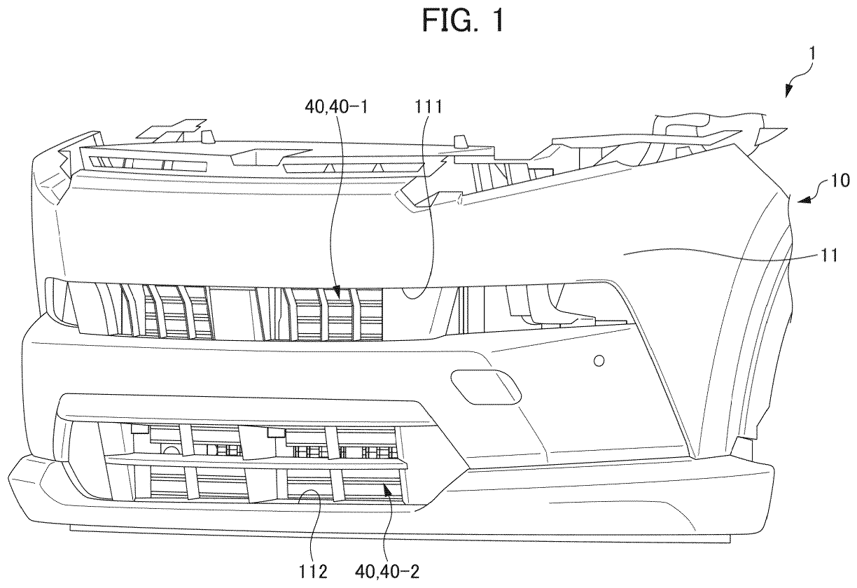

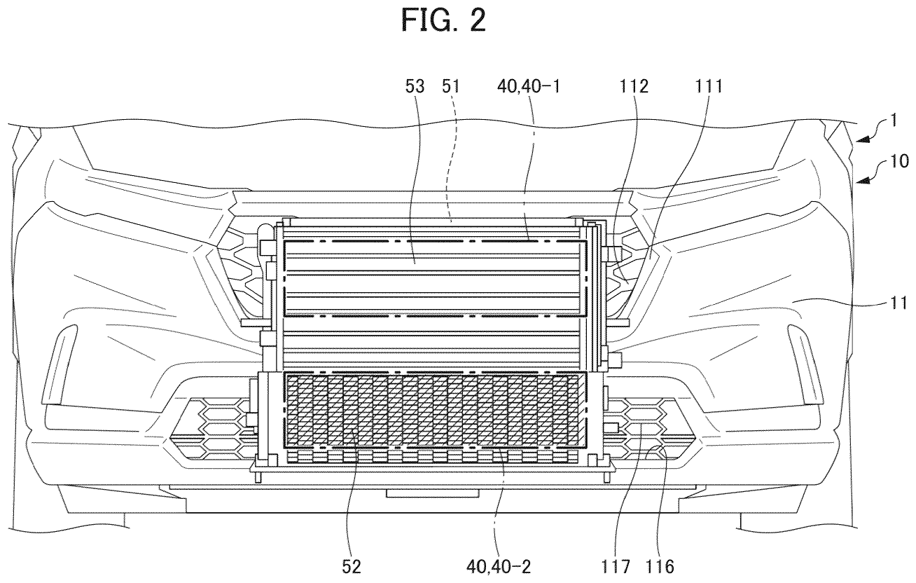

With reference to the drawings, description is given below regarding embodiments of the present invention. In the following description, forward and rearward, left and right, and up and down are described by being matched to directions seen from a driver of a vehicle. FIG. 1 is a perspective view and FIG. 2 is a front view, each illustrating a front section of a vehicle 1 that is provided with a temperature adjustment apparatus according to a first embodiment of the present invention. The vehicle 1 according to the present embodiment is a hybrid electric vehicle (HEV).

As illustrated in FIG. 1 and FIG. 2, a front section of a vehicle body 10 that is included in the vehicle 1 is provided with a front bumper 11 that extends left and right. An upper opening 111 and a lower opening 116 are formed in the front bumper 11, and these configure grill openings. A front upper grill 112 and a front lower grill 117, which have honeycomb meshes, are respectively attached to the upper opening 111 and the lower opening 116.

As illustrated in FIG. 2, the upper opening 111 is formed in an upper section of the front bumper 11, at the center of the vehicle body 10 in the width direction thereof. The upper opening 111 has a rectangular shape that is long in the width direction of the vehicle body 10, in a front view of the vehicle body 10 illustrated in FIG. 2. As illustrated in FIG. 2, the lower opening 116 is formed in a lower section of the front bumper 11, at the center of the vehicle body 10 in the width direction thereof. The lower opening 116 has a rectangular shape that is long in the width direction of the vehicle body 10, in a front view of the vehicle body 10 illustrated in FIG. 2.

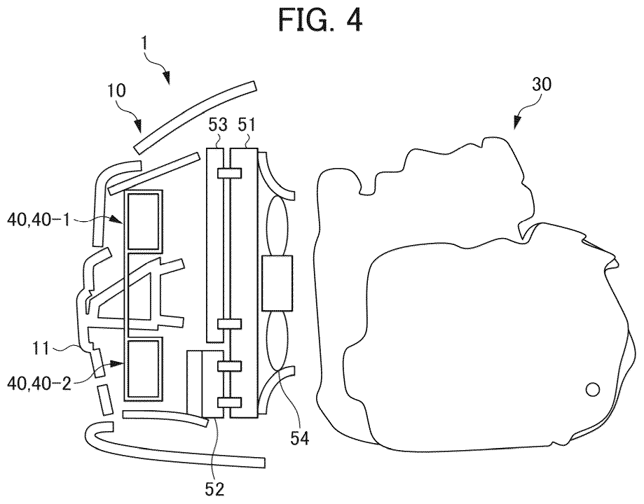

As illustrated in FIG. 4, a drive unit 30 that serves as a motive power source is provided at substantially the center of the front section of the vehicle body 10. The drive unit 30 is supported by a pair of front side frames that are not illustrated and extend in the forward-rearward direction of the vehicle 1, for example. The drive unit 30 includes an engine, a motor, a transmission, and an electric power conversion apparatus.

A cooling mechanism that includes a first radiator 51 that serves as an engine radiator (ENG RAD), a second radiator 52 that serves as a motor radiator (HEV RAD), and a condenser 53 that serves as an air conditioner condenser (A/C COND) is disposed at a position that is forward from the drive unit 30, rearward from the grill shutters 40, and approximately central in the vehicle width direction of the vehicle 1. A fan shroud 54 is disposed rearward (on the right side in FIG. 4) from the cooling mechanism. The second radiator 52 is disposed in front (on the left side in FIG. 4) of a lower section of the first radiator 51. The condenser 53 is disposed in front (on the left side in FIG. 4) of an upper section of the first radiator 51.

The first radiator 51 is a heat dissipation apparatus that is provided in a cooling circuit for cooling the engine, and dissipates, to outside air, heat from a coolant that circulates through the cooling circuit. In order to cool the engine, which generates a large amount of heat, the first radiator 51 is configured to be larger than the second radiator 52 or the condenser 53. The second radiator 52 is a heat dissipation apparatus that is provided in a cooling circuit for cooling the electric power conversion apparatus, is different to the cooling circuit for cooling the engine, and dissipates, to outside air, heat from a coolant that circulates through this cooling circuit. The condenser 53 is a member for dissipating, to outside air, heat of condensation from a coolant circuit belonging to an air-conditioning apparatus in the vehicle 1.

The fan shroud 54 has a rectangular parallelepiped shaped exterior having a shape and size that substantially correspond to the shape of the first radiator 51. The fan shroud 54 is disposed at the rear side of the first radiator 51, which is disposed at the rear side of the later-described grill shutters 40, in an overlapping positional relationship that substantially matches with the first radiator 51.

Accordingly, as illustrated in FIG. 4, a lower section of the fan shroud 54 is disposed in a positional relationship that overlaps with the rear side (right side in FIG. 4) of the second radiator 52.

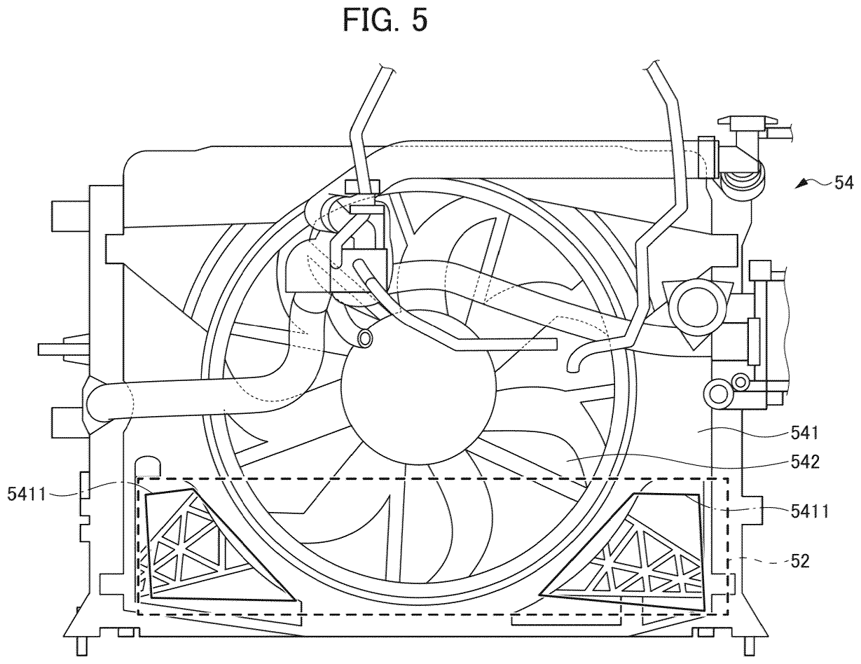

As illustrated in FIG. 5, the fan shroud 54 includes a frame body 541 that has a rectangular parallelepiped shaped exterior, and a cooling fan 542 that corresponds to a rotor and is disposed at the center of the frame body 541. At a time of aftercooling for after the vehicle 1 is stopped and not only when the vehicle 1 is traveling, for example, the cooling fan 542 increases the air volume passing through the first radiator 51, the second radiator 52, and the condenser 53 by operating and rotating in circumstances where the temperature of the coolant that circulates through the cooling circuit for cooling the engine in the drive unit 30 that is the motive power source for the vehicle 1, the temperature of the coolant that circulates through the cooling circuit for cooling the electric power conversion apparatus, the temperature of the coolant in the coolant circuit in the air-conditioning apparatus in the vehicle 1, or the oil temperature of a front drive unit (FDU) has become greater than or equal to a prescribed temperature that is respectively set in advance. As a result, configuration is such that later-described second flaps 41-2 enter an open state due to the dynamic pressure of air flowing in through the grill shutters 40.

The frame body 541 in the fan shroud 54 is provided with openings 5411. Each opening 5411 is configured by a through hole such that a portion near each of two corners of a lower section of the frame body 541, which has a rectangular parallelepiped shaped exterior, is penetrated in the forward-rearward direction. As described above, the lower section of the fan shroud 54 is disposed in a positional relationship that overlaps with the rear side of the second radiator 52, as illustrated in FIG. 4. Therefore, the openings 5411 are disposed at positions that overlap with the second radiator 52 in the forward-rearward direction of the vehicle body 10, as illustrated in FIG. 5.

A top-side grill shutter 40-1 and a bottom-side grill shutter 40-2 that each configure a temperature adjustment apparatus are provided rearward from each of the upper opening 111 and the lower opening 116, which configure grill openings, and forward from each of the condenser 53 and the second radiator 52. The top-side grill shutter 40-1 and the bottom-side grill shutter 40-2 cover the upper opening 111 and the lower opening 116, respectively. The top-side grill shutter 40-1 and the bottom-side grill shutter 40-2 are generically referred to below as a grill shutter 40.

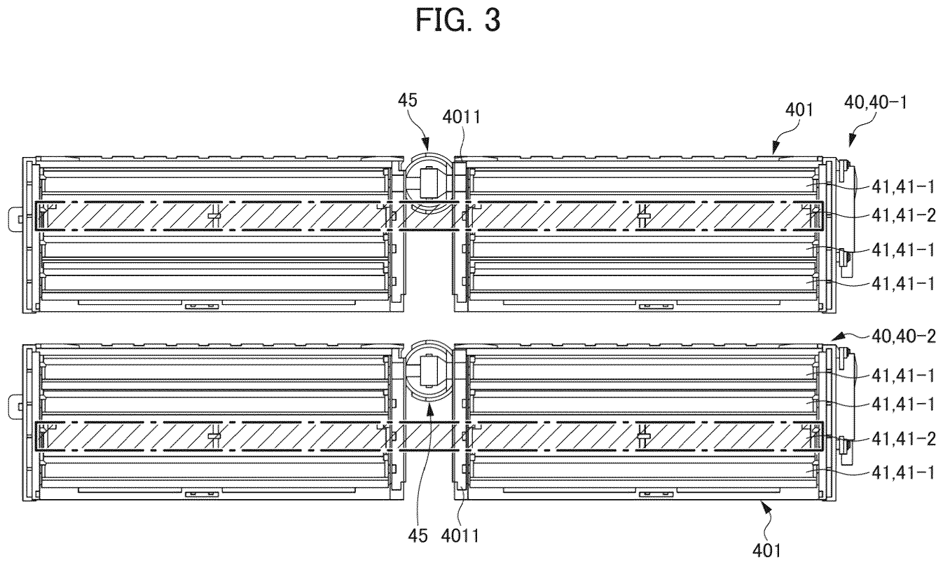

The top-side grill shutter 40-1 and the bottom-side grill shutter 40-2 differ in the position at which the second flap 41-2 is disposed as illustrated in FIG. 3, but have the same configuration in other features. Therefore, description is given mainly regarding the bottom-side grill shutter 40-2, and description regarding the top-side grill shutter 40-1 is omitted.

Each grill shutter 40 includes flaps 41 (first flaps 41-1, second flap 41-2), and a frame body 401. The frame body 401 is configured by being formed into a rectangular frame, and has a rectangular shape that is long in the width direction of the vehicle 1. The first flaps 41-1 and the second flap 41-2 have different shapes for later-described supported sections 412, but are otherwise identical.

In the top-side grill shutter 40-1, the first, third, and fourth flaps from the top are configured by first flaps 41-1, and the second flap from the top is configured by the second flap 41-2. In the bottom-side grill shutter 40-2, the first, second, and fourth flaps from the top are configured by first flaps 41-1, and the third flap from the top is configured by the second flap 41-2. As a result, in each of the upper opening 111 and the lower opening 116, the opening area of a portion for the second flap 41-2 is smaller than the total of the opening areas of portions for the three first flaps 41-1. In addition, the second flap 41-2 in the bottom-side grill shutter 40-2 is disposed at a position that overlaps, in the forward-rearward direction for the vehicle body 10, with the second radiator 52 that serves as the motor radiator.

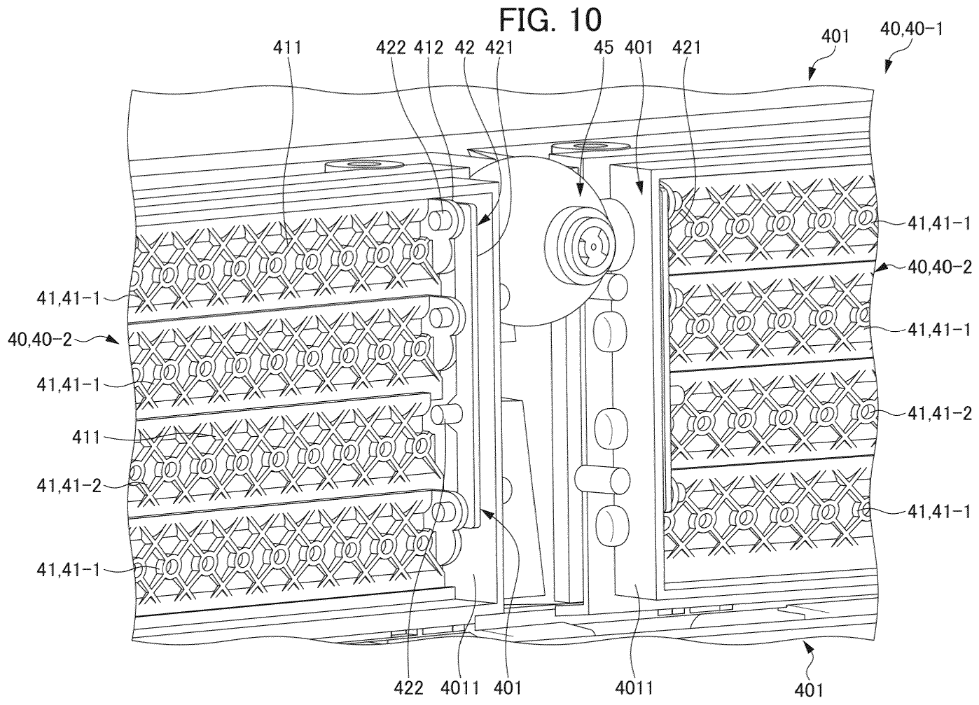

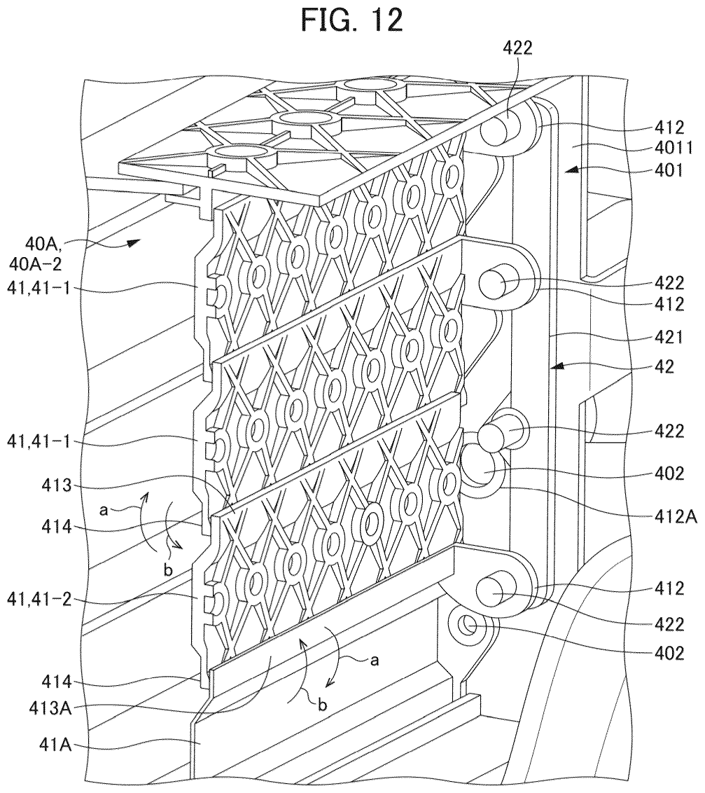

As illustrated in FIG. 3 and FIG. 10, each flap 41 has a rectangular plate-shaped section 411 (refer to FIG. 10) and supported sections 412 (refer to FIG. 10) that are plate-shaped, protrude in a direction orthogonal to the plate-shaped section 411, and are provided respectively connected in an integral fashion to one end and the other end of the plate-shaped section 411 in the longitudinal direction thereof that matches the width direction of the vehicle 1. Lower sections of the supported sections 412 of each of the first flaps 41-1 and the second flap 41-2 are each supported, in a manner that allows rotation, by a cylindrical protruding section 402 (refer to FIG. 12) of a vertical frame 4011 that belongs to the frame body 401.

As a result, the first flaps 41-1 and the second flap 41-2 are arranged in the frame body 401. Upper sections of the supported sections 412 of the plurality of first flaps 41-1 are joined and connected to each other by a link 42. The link 42 has a long plate-shaped link body section 421, and a plurality of cylindrical protruding sections 422 that protrude from one surface of the link body section 421.

More specifically, the upper sections of the supported sections 412 of the plurality of first flaps 41-1 configure a connection section that is connected to the link 42, and each is supported by a cylindrical protruding section 422 in a manner that allows rotation. The link body section 421 moves in an up-down direction as described below, whereby the supported sections 412 of the plurality of first flaps 41-1 rotate in synchronization about the axis of the respective cylindrical protruding section 402 (refer to FIG. 12) of the vertical frame 4011.

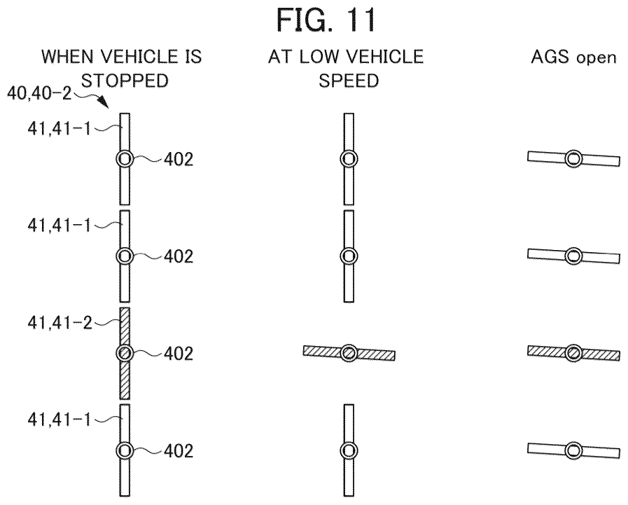

As a result, configuration is taken such that, as illustrated in FIG. 11, it is possible to switch between a closed state for the first flaps 41-1 in which the upper opening 111 and the lower opening 116 that configure grill openings are closed and there is a positional relationship in which the front surface and the back surface of the plate-shaped section 411 of each first flap 41-1 are substantially parallel to the up-down direction, and an open state for the first flaps 41-1 in which the upper opening 111 and the lower opening 116 that configure grill openings are open and there is a positional relationship in which the front surface and the back surface of the plate-shaped section 411 of each first flap 41-1 are substantially parallel to a horizontal direction.

The supported sections 412 of the second flap 41-2 lack a portion that corresponds to the upper sections of the supported sections 412 of the first flaps 41-1. Accordingly, the supported sections 412 of the second flap 41-2 are disposed separated from the link 42. Accordingly, even if the link body section 421 moves in the up-down direction, the supported sections 412 of the second flap 41-2 are configured not to be caused to rotate about the axis of a cylindrical protruding section 402 of the vertical frame 4011.

By virtue of this configuration, the second flap 41-2 is configured to enter the open state due to dynamic pressure greater than or equal to a certain level and enter the closed state due to dynamic pressure less than the certain level, regardless of prescribed states (a first prescribed state and a second prescribed state that are described below) of the motive power source, including the temperature state of the motive power source (engine or motor). Specifically, when the vehicle 1 is traveling at a speed that is greater than or equal to a prescribed speed or when the cooling fan 542 in the fan shroud 54 is rotating at a rotation speed that is greater than or equal to a prescribed rotation speed, dynamic pressure greater than or equal to the certain level air pressing the plate-shaped section 411 of the second flap 41-2 causes the supported sections 412 of the second flap 41-2 to rotate around the axis of the cylindrical protruding section 402 of the vertical frame 4011, whereby the second flap 41-2 enters the open state. When the plate-shaped section 411 of the second flap 41-2 is not receiving such a dynamic pressure that is greater than or equal to the certain level, the second flap 41-2 enters the closed state.

A gearing 45 for setting the first flaps 41-1 to the open state or closed state is provided to the top-side grill shutter 40-1 and the bottom-side grill shutter 40-2. As illustrated in FIG. 3, the gearing 45 is integrally connected, in a manner that allows rotation, to first flaps 41-1 that are at the uppermost level of top-side grill shutters 40-1 to the left and right and at the uppermost level of bottom-side grill shutters 40-2 to the left and right. The gearing 45 is joined, via a gear mechanism, to a motor that is not illustrated.

Configuration is taken such that the motor performs driving due to control by a control apparatus (not illustrated), whereby rotation by the motor is transmitted to the gearing 45, and the first flaps 41-1 at the uppermost level of the left and right top-side grill shutter 40-1 integrally rotate around an axis that is directed to the left-right direction in FIG. 3 and is the left-right direction for the vehicle body 10. For the bottom-side grill shutter 40-2, configuration is similarly taken such that the motor (not illustrated) performs driving due to control by a control apparatus (not illustrated), whereby rotation by the motor is transmitted to the gearing 45, and the first flaps 41-1 at the uppermost level of the left and right bottom-side grill shutters 40-2 integrally rotate around an axis that is directed to the left-right direction in FIG. 3 and is the left-right direction for the vehicle body 10.

As described above, for the top-side grill shutter 40-1 and the bottom-side grill shutter 40-2, the upper sections of the supported sections 412 for the plurality of first flaps 41-1 are joined and connected to each other by the link 42. Accordingly, the first flaps 41-1 at the uppermost level in the top-side grill shutter 40-1 and the bottom-side grill shutter 40-2 are caused to rotate by the gearing 45, whereby the link 42 is caused to move vertically, the third and fourth first flaps 41-1 from the top in the top-side grill shutter 40-1 are caused to rotate to achieve the same angle as that of the first flap 41-1 at the uppermost level, and the second and fourth first flaps 41-1 from the top in the bottom-side grill shutter 40-2 are caused to rotate to achieve the same angle as that of the first flap 41-1 at the uppermost level.

Each first flap 41-1 is configured to enter the open state in which the front surface and the back surface of the plate-shaped section 411 of the first flap 41-1 achieve a positional relationship of being substantially parallel to the horizontal direction due to the gearing 45 being driven due to control by the control apparatus (not illustrated) and the link 42 moving downward when the motive power source in the vehicle 1 has entered a first prescribed state while the vehicle 1 is traveling.

The first prescribed state here means a state in which the temperature of the coolant that circulates through the cooling circuit for cooling the engine that is in the drive unit 30 and is connected to the first radiator 51, the temperature of the coolant that circulates through the cooling circuit for cooling the electric power conversion apparatus that is connected to the second radiator 52, the temperature of the coolant in the coolant circuit in the air-conditioning apparatus that is in the vehicle 1 and is connected to the condenser 53, or the oil temperature of the FDU has become greater than or equal to a prescribed temperature that is respectively set in advance.

In contrast to this, a state in which the above-described temperature of the coolant that circulates through the cooling circuit for cooling the engine in the drive unit 30, the temperature of the coolant that circulates through the cooling circuit for cooling the electric power conversion apparatus, the temperature of the coolant in the coolant circuit in the air-conditioning apparatus in the vehicle 1, and the oil temperature of the FDU are all less than the prescribed temperature that is set in advance is defined as a second prescribed state.

Each first flap 41-1 is configured to enter the closed state in which the front surface and the back surface of the plate-shaped section 411 of the first flap 41-1 achieve a positional relationship of being substantially parallel to the up-down direction due to the gearing 45 being driven due to control by the control apparatus (not illustrated) and the link 42 moving upward when the motive power source in the vehicle 1 has entered the second prescribed state while the vehicle is traveling.

For example, when the motive power source in the vehicle 1 has entered the second prescribed state while the vehicle 1 is stopped, each first flap 41-1 is set to the closed state in which the front surface and the back surface of the plate-shaped section 411 (refer to FIG. 10) of the first flap 41-1 are in a positional relationship of being substantially parallel to the up-down direction, as illustrated on the left side in FIG. 11, due to the gearing 45 and the link 42. At this point, the vehicle 1 is stopped and thus the second flap 41-2 does not receive dynamic pressure. Therefore, the second flap 41-2 that is not connected to the link 42 is kept in the closed state in which the front surface and the back surface of the plate-shaped section 411 (refer to FIG. 10) belonging to the second flap 41-2 are in a positional relationship of being substantially parallel to the up-down direction.

When the motive power source in the vehicle 1 has entered the second prescribed state while the vehicle 1 is traveling at low speed, the closed state is entered in which the front surface and the back surface of the plate-shaped sections 411 (refer to FIG. 10) of the first flaps 41-1 are in a positional relationship of being substantially parallel to the up-down direction, as illustrated in the middle of FIG. 11, due to the link 42 being at a similar position to that when the vehicle 1 is stopped. In contrast, when the second flap 41-2 does not receive prescribed dynamic pressure due to low-speed travel by the vehicle 1, due to the dynamic pressure, the second flap 41-2 that is not connected to the link 42 rotates around the cylindrical protruding section 402 of the vertical frame 4011 belonging to the frame body 401 to thereby enter an open state in which the front surface and the back surface of the plate-shaped section 411 (refer to FIG. 10) of the second flap 41-2 achieve a positional relationship of being substantially parallel to the horizontal direction.

When the motive power source in the vehicle 1 has entered the first prescribed state while the vehicle 1 is traveling, the gearing 45 is driven and the link 42 moves downward, whereby the open state is entered in which the front surface and the back surface of the plate-shaped section 411 (refer to FIG. 10) of each first flap 41-1 are in a positional relationship of being substantially parallel to the horizontal direction, as illustrated on the right side in FIG. 11. At this point, when the second flap 41-2 receives prescribed dynamic pressure due to the travel by the vehicle 1, due to the dynamic pressure, the second flap 41-2 that is not connected to the link 42 rotates around the cylindrical protruding section 402 of the vertical frame 4011 belonging to the frame body 401 to thereby enter the open state in which the front surface and the back surface of the plate-shaped section 411 (refer to FIG. 10) of the second flap 41-2 achieve a positional relationship of being substantially parallel to the horizontal direction.

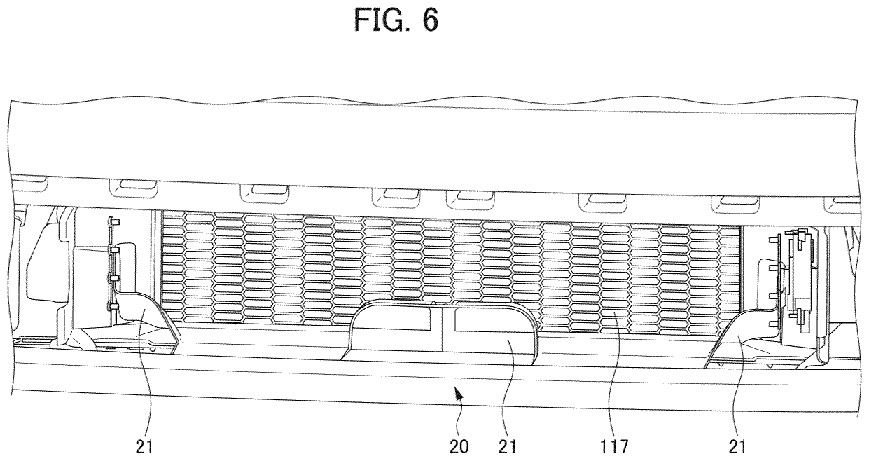

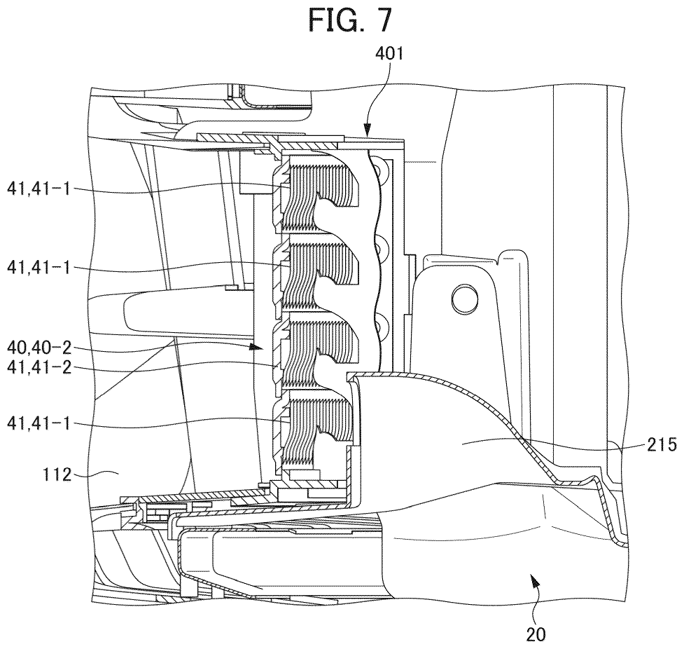

As illustrated in FIG. 6 through FIG. 9, the vehicle body 10 is provided with ventilation openings 21 that are at the rearward lower section of the bottom-side grill shutter 40-2 and are lower in the up-down direction than the second flap 41-2 in the bottom-side grill shutter 40-2. The ventilation openings 21 are formed, in the engine undercover 20, at each of left and right ends as well as at the center of the rearward lower section of the bottom-side grill shutter 40-2. The ventilation opening 21 at the center is in communication with a central space on the top surface of an engine undercover 20. The ventilation openings 21 at the left and right ends are in communication with the inside of cooling ducts 22 that extend from the left and right ends to the rear of the vehicle body 10.

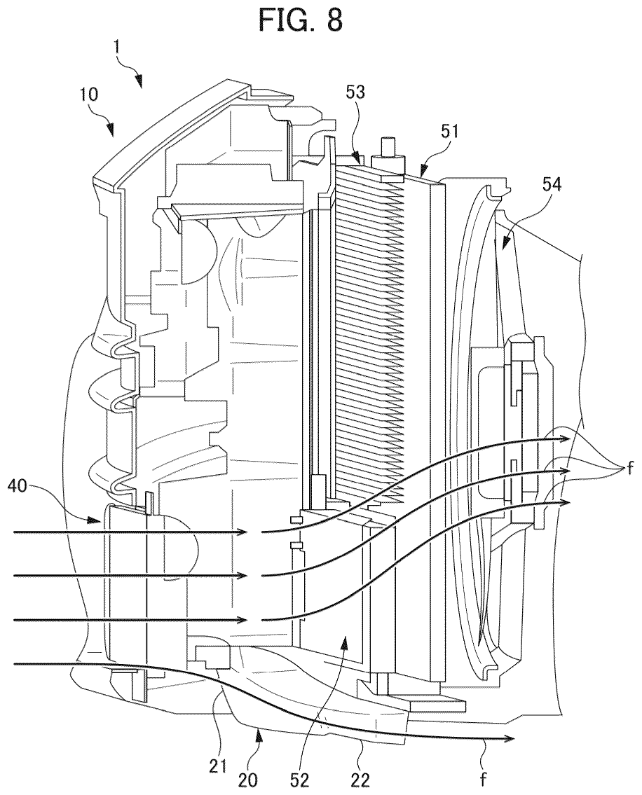

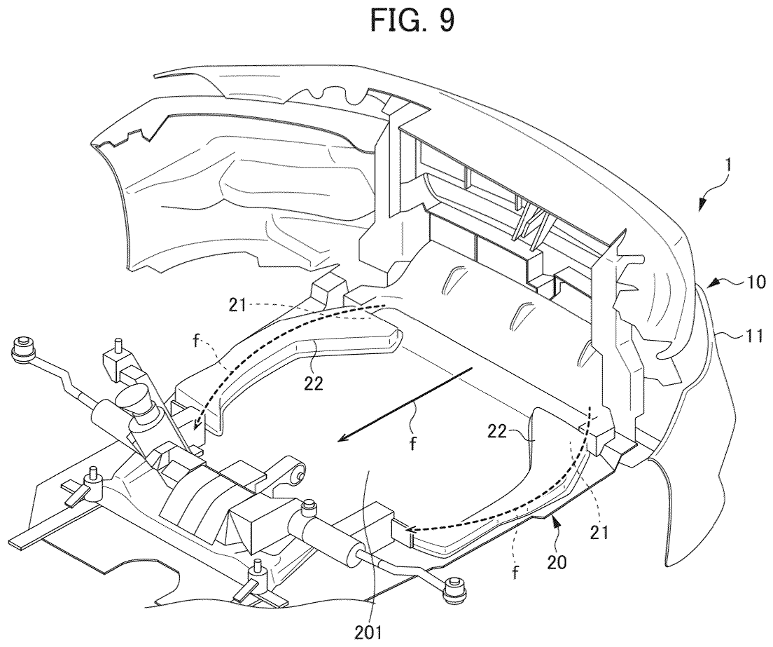

As illustrated in FIG. 8 and FIG. 9, configuration is taken such that air f that has passed through the lower section of the bottom-side grill shutter 40-2 flows in through the ventilation openings 21, passes through the central space on the top surface of the engine undercover 20 and through the cooling ducts 22, and respectively flows rearward thereof. As illustrated in FIG. 8, configuration is taken such that the air f that has passed through the middle and upper sections of the bottom-side grill shutter 40-2 cools the second radiator 52 that serves as a motor radiator, cools the first radiator 51 that serves as an engine radiator, flows rearwardly due to the cooling fan 542 in the fan shroud 54, and is supplied rearward through the opening 5411 in the frame body 541 belonging to the fan shroud 54.

In the present embodiment described above, the flaps 41 arranged in the frame body 401 include first flaps 41-1 that enter the open state when the motive power source in the vehicle 1 has entered the first prescribed state, and the second flap 41-2 that has a smaller opening area than that of the first flaps 41-1 and enters the open state regardless of the first prescribed state or the second prescribed state for the motive power source.

As a result, even if the second prescribed state is reached in which a temperature for a condenser or a battery (such as the temperature of the coolant in the second radiator 52 or the condenser 53) has become less than or equal to a prescribed temperature and the first flaps 41-1 have entered the closed state, it is possible to set a portion of the grill shutter 40 to an open state and it is possible to set the entirety of the grill shutter 40 to a closed state while the vehicle 1 is stopped and while the vehicle 1 is traveling at low speed. As a result, while the vehicle 1 is traveling, it is possible to reduce air resistance and improve the appearance and merchantability of the vehicle 1, and it becomes possible suppress and delay the temperature of the coolant in the second radiator 52 or the condenser 53 reaching a prescribed temperature at which the entirety of the grill shutter 40 opens.

In addition, even in a case where the grill shutter 40 opens while the vehicle 1 is stopped such as at a time of charging or aftercooling, by providing the second flap 41-2, it is possible to set only a portion of the grill shutter 40 to open, and thus it becomes possible to suppress a drop in the appearance and merchantability of the vehicle 1.

In addition, in the present embodiment, the fan shroud 54 is provided rearward of the grill shutter 40, and the second flap 41-2 enters the open state when the fan shroud 54 is operated. As a result, when the fan shroud 54 is operated, the second flap 41-2 enters the open state, whereby it is possible to produce an air flow using the fan shroud 54.

Accordingly, it becomes possible to suppress and delay a rise in temperature for the engine, motor, battery, etc. that serve as the motive power source (a rise in temperature of the coolant in the first radiator 51, the second radiator 52, or the condenser 53), and the second flap 41-2 is set to the open state without setting the first flaps 41-1 to the open state, whereby air resistance while the vehicle 1 is traveling is suppressed.

In addition, in the present embodiment, the fan shroud 54 operates when the engine, motor, battery, etc. that serve as the motive power source in the vehicle 1 have reached a prescribed temperature or more.

As a result, the fan shroud 54 is caused to operate when the temperature of the coolant in the first radiator 51, the second radiator 52, or the condenser 53 has reached the prescribed temperature or more, whereby the second flap 41-2 enters the open state. Therefore, it is possible to suppress a rise in the temperature of the coolant in the first radiator 51, the second radiator 52, and the condenser 53, and it becomes possible to improve the appearance and merchantability of the vehicle 1 by setting only the second flap 41-2 to the open state at a time of cooling while the vehicle 1 is stopped, such as cooling after the vehicle 1 has traveled or for heat generated when charging.

In addition, in the present embodiment the second flap 41-2 enters the open state due to dynamic pressure of a certain level or more, regardless of prescribed states (first prescribed state and second prescribed state) for the motive power source (first radiator 51, second radiator 52, and condenser 53). As a result, it becomes possible to set the gearing 45 for causing the flaps 41 to open and close to be for opening and closing the first flaps 41-1 and, because there is no need to provide a gearing for the second flap 41-2, the weight and cost incurred by the apparatus are reduced.

In addition, the second flap 41-2 enters the open state due to the dynamic pressure of a certain level or more, whereby it becomes possible for the second flap 41-2 not to enter the open state due to natural wind while the vehicle 1 is stopped or traveling wind while the vehicle 1 is traveling slowly, and it becomes possible to suppress air resistance while the vehicle 1 is traveling to thereby improve the appearance and merchantability thereof.

In addition, in the present embodiment, the vehicle 1 is provided with the cooling mechanism that is rearward from the grill shutter 40, the cooling mechanism includes the first radiator 51, the second radiator 52, and the condenser 53, and the second flap 41-2 is provided at a position that overlaps with the second radiator in the forward-rearward direction for the vehicle body 10.

The temperature (a required temperature) that is required for the coolant in the second radiator 52 that serves as the motor radiator (HEV RAD) is lower than required temperatures for the first radiator 51 that serves as the engine radiator and the condenser 53 that serves as the air conditioner condenser. Therefore, it is necessary to further cool the second radiator 52 and achieve a lower temperature for the second radiator 52. By virtue of the configuration described above, the second flap 41-2 is disposed at a position that overlaps with the second radiator 52 in the forward-rearward direction for the vehicle 1, whereby it becomes possible to use the flow of air while the second flap 41-2 can move to achieve a lower temperature for the second radiator 52.

In addition, in the present embodiment, the fan shroud 54 is provided rearward of the cooling mechanism, the fan shroud 54 includes the frame body 541 and the cooling fan 542 that corresponds to a rotor and is disposed at the center of the frame body 541, and the frame body 541 is provided with the opening 5411 at a position that overlaps in the vehicle body forward/rearward direction with the second radiator 52 that serves as the motor radiator.

As a result, by driving the fan shroud 54, it is possible to enable the second flap 41-2 to move, and thus it is possible to enable the second flap 41-2 to move if necessary, even when the vehicle 1 is not traveling at low speed. For example, in a case of using the gearing to drive the flaps 41, all of the flaps 41 will operate, leading to a drop in appearance and merchantability. Therefore, it is necessary to enable only the second flap 41-2 to move. In such a case, the frame body 541 belonging to the fan shroud 54 is provided with the opening 5411, whereby it is possible to supply, to the opening 5411 side, air flow that has flowed to the cooling fan that corresponds to a rotor. Accordingly, the second radiator 52 that corresponds to the motor radiator is disposed at a position that overlaps with the opening 5411 in the forward-rearward direction, whereby it is possible to further cool the second radiator 52.

In addition, in the present embodiment, each grill shutter 40 includes a gearing 45 for setting the first flaps 41-1 to the open state or the closed state and the link 42 that is connected to the plurality of first flaps 41-1, and the second flap 41-2 is disposed separated from the link 42.

As a result, the plurality of first flaps 41-1 are connected to the link 42 and the second flap 41-2 is disposed separated from the link 42, whereby it is possible to constrain an increase in the number of gearings 45 for driving the flaps 41 and set the second flap 41-2 to the open state regardless of opening and closing in accordance with the gearing 45.

In addition, in the present embodiment, the first flaps 41-1 have, at ends of the first flaps 41-1 in the width direction thereof, supported sections 412 that correspond to connection sections to which the link 42 is connected to. As a result, the supported sections 412 of the first flaps 41-1 are connected and joined to each other by the link 42, whereby it is possible to use one gearing 45 to set the plurality of first flaps 41-1 to the open state or the closed state.

In addition, in the present embodiment, the ventilation openings 21 are provided at a rearward lower section of the grill shutter 40, and the second flap 41-2 is positioned upward from the ventilation openings 21 in the up-down direction. As a result, the second flap 41-2 is positioned upward from the ventilation openings 21, whereby, in case where only the second flap 41-2 is enabled to move while the vehicle 1 is traveling at low speed, it is possible to produce an air flow toward the cooling mechanism (the first radiator 51, the second radiator 52, and the condenser 53). Accordingly, in a case where, for example, the second flap 41-2 is disposed at the same height as the ventilation openings 21, there would be the difficulty in that air that has passed through the second flap 41-2 would flow directly into the ventilation openings 21 in an unchanged manner, increasing the air volume supplied to the cooling mechanism, but it is possible to avoid this difficulty.

Next, description is given regarding a second embodiment. The second embodiment differs from the first embodiment in that a contact driving member that is not joined to the second flap 41-2 and can separate from and come into contact with the second flap 41-2 is provided on the link 42. Because other points are similar to those in the first embodiment, description thereof is omitted.

The link 42 is provided with a flap drive link arm (not illustrated) that serves as a contact driving member. In conjunction with downward movement by the link 42, the first flaps 41-1 rotate in a direction indicated by an arrow a in FIG. 12. In conjunction therewith, the flap drive link arm (not illustrated) comes into contact with the second flap 41-2 from a separated state, and press an upper section of the back side of the second flap 41-2 illustrated in FIG. 12 in a bottom-right direction in FIG. 12. As a result, the flap drive link arm (not illustrated) causes the second flap 41-2 to rotate around the cylindrical protruding section 402, whereby an open state is entered in which the front surface and back surface of the plate-shaped section 411 belonging to the second flap 41-2 achieve a positional relationship of being substantially parallel to the horizontal direction.

The second flap 41-2 being set to the open state by dynamic pressure is similar to in the first embodiment. The first flaps 41-1 rotating in a direction indicated by an arrow b in FIG. 12 in conjunction with upward movement by the link 42 is similar to in the first embodiment.

In the present embodiment, the link 42 is provided with the flap drive link arm that serves as a contact driving member, and the flap drive link arm presses the second flap 41-2 to set the second flap 41-2 to the open state when the first flaps 41-1 are in the open state. As a result, the second flap 41-2 can move to the open state due to dynamic pressure, and it is possible for the second flap 41-2 to operate together with the first flaps 41-1 due to being pressed by the contact driving member when the gearing 45 has operated.

Description was given above regarding embodiments and variations of the present invention, but there is no limitation to the above-described embodiments and variations. In addition, effects described in the embodiments and variations are merely lists of suitable effects, and are not limited to those described in the embodiments above.

For example, in the present embodiment, the first prescribed state here means a state in which the temperature of the coolant that circulates through the cooling circuit for cooling the engine that is in the drive unit 30, the temperature of the coolant that circulates through the cooling circuit for cooling the electric power conversion apparatus, the temperature of the coolant in the coolant circuit in the air-conditioning apparatus that is in the vehicle 1, or the oil temperature of the FDU has become greater than or equal to a prescribed temperature that is respectively set in advance. In addition, the second prescribed state means a state in which the temperature of the coolant that circulates through the cooling circuit for cooling the engine in the drive unit 30, the temperature of the coolant that circulates through the cooling circuit for cooling the electric power conversion apparatus, the temperature of the coolant in the coolant circuit in the air-conditioning apparatus in the vehicle 1, and the oil temperature of the FDU are all less than the prescribed temperature that is set in advance, but the first prescribed state and the second prescribed state are not limited thereto.

In addition, for example, it may be that another gearing that differs from the gearing 45 is provided, and the second flap 41-2 is switched between the open state and the closed state by the other gearing. Switching between the open state and the closed state by the other gearing may be performed at the time of another prescribed state that differs from the first prescribed state and the second prescribed state.

### EXPLANATION OF REFERENCE NUMERALS

1 Vehicle
21 Ventilation opening
40 Grill shutter
40-1 Top-side grill shutter
40-2 Bottom-side grill shutter
41 Flap
41-1 First flap
41-2 Second flap
42 Link
45 Gearing
51 First radiator (engine radiator)
52 Second radiator (motor radiator)
53 Condenser (air conditioner condenser)
54 Fan shroud
111 Upper opening (grill opening)
116 Lower opening (grill opening)
401 Frame body
412 Supported section (connection section)
541 Frame body
542 Cooling fan (rotor)
5411 Opening

What is claimed is:

1. A temperature adjustment apparatus for a vehicle, the apparatus comprising:
a grill opening formed in a front section of the vehicle; and
a grill shutter that covers the grill opening, wherein
the grill shutter includes
a plurality of flaps for setting the grill opening to an open state or a closed state, and
a frame body in which the flaps are arranged, and
the flaps arranged in the frame body include
a first flap that enters an open state or a closed state when a motive power source in the vehicle enters a prescribed state, and
a second flap that has a smaller opening area than an opening area for the first flap and enters an open state or a closed state regardless of the prescribed state of the motive power source.

2. The temperature adjustment apparatus according to claim 1, further comprising
a fan shroud that is rearward from the grill shutter, wherein
the second flap enters the open state when the fan shroud operates.

3. The temperature adjustment apparatus according to claim 2, wherein the fan shroud operates when the motive power source in the vehicle reaches a prescribed temperature or more.

4. The temperature adjustment apparatus according to claim 1, wherein the second flap enters the open state due to dynamic pressure that is a certain level or more and regardless of the prescribed state of the motive power source.

5. The temperature adjustment apparatus according to claim 1, wherein
the vehicle includes a cooling mechanism that is rearward from the grill shutter,
the cooling mechanism includes an engine radiator, a motor radiator, and an air conditioner condenser, and
the second flap is disposed at a position that overlaps with the motor radiator in a vehicle body forward/rearward direction.

6. The temperature adjustment apparatus according to claim 5, further comprising
a fan shroud that is rearward from the cooling mechanism, wherein
the fan shroud includes a frame body and a rotor that is disposed at a center of the frame body, and
the frame body includes an opening at a position that overlaps with the motor radiator in the vehicle body forward/rearward direction.

7. The temperature adjustment apparatus according to claim 1, wherein
the grill shutter includes
a gearing that sets the first flap to the open state or the closed state, and
a link that is connected to the plurality of first flaps, and
the second flap is disposed separated from the link.

8. The temperature adjustment apparatus according to claim 7, wherein
the first flap has, at an end in the width direction of the first flap, a connection section that is connected to the link.

9. The temperature adjustment apparatus according to claim 8, wherein
the link includes a contact driving member, and
when the first flap is in the open state, the contact driving member presses on the second flap to set the second flap to the open state.

10. The temperature adjustment apparatus according to claim 1, further comprising
a ventilation opening at a rearward lower section of the grill shutter, wherein
the second flap is positioned upward from the ventilation opening in an up-down direction.
